(19) United States
(12) Patent Application Publication
(10) Pub. No.: US 2012/0138703 A1
(43) Pub. Date: Jun. 7, 2012

(54) Dual Fan Sprayer

(76) Inventor: Mario VanDyke, Conklin, MI (US)

(21) Appl. No.: 13/312,561

(22) Filed: Dec. 6, 2011

Related U.S. Application Data
(60) Provisional application No. 61/459,113, filed on Dec. 6, 2010.

(51) Int. Cl. B05B 9/06

(52) U.S. Cl. 239/77

(57) ABSTRACT

A spray unit and process for controlled droplet atomization for use particularly in an orchard, wherein air is urged under pressure in substantially opposite directions in response to the actuation of dual, counter-rotating fans. The fans are, in one embodiment, driven by a motor that is coupled to the fans by a serpentine belt. The flowing air receives droplets of material to be substantially atomized from one or more motor-powered atomizers. The spray unit is easily retrofitted to be installed on a convention sprayer cart or tractor-pulled trailer.

### BACKGROUND OF THE INVENTION

1. Field of the Invention

This invention relates generally to agricultural equipment, and more particularly, to a sprayer arrangement that is particularly suited for use in an orchard.

2. Description of the Related Art

The prior art has employed a wide variety of high velocity fans, turbines, air nozzles, and the like for blowing air transversely across or through the plane of droplet generated by controlled droplet atomizers. This has cause random dispersion of the droplets, or particles in the case of orchards, resulting in uneven dispersion. It is a further problem that the high velocity application of active ingredient has resulted in masking of the atomized stream by foreground foliage, and this has further prevented the delivery of the atomized material to background foliage.

It is, therefore, an object of this invention to provide a sprayer arrangement that delivers atomized material uniformly to background foliage, as well as to foreground foliage.

It is another object of this invention to provide an orchard sprayer arrangement that readily can be adapted for use with existing sprayer carriers, such as trailers and carts.

### SUMMARY OF THE INVENTION

The foregoing and other objects are achieved by this invention which provides a sprayer arrangement having a pair of elongated fans that are arranged in axially parallel relation. A drive arrangement rotates the elongated fans simultaneously in counter-rotation with respect to each other.

In one embodiment of the invention, the drive arrangement is provided with a motor and a coupler arrangement that couples the motor to the pair of drive fans. In a highly advantageous embodiment of the invention, the coupler arrangement is a serpentine drive belt.

There is additionally provided an atomizer arrangement for delivering a material to be atomized to the vicinity of said pair of elongated fans.

The pair of elongated fans are configured to urge air in respective transaxial directions. A housing is arranged to surround the pair of elongated fans, the housing having a pair of lateral ports for exhausting the air that is transaxially urged by said pair of elongated fans with the material to be atomized.

### BRIEF DESCRIPTION OF THE DRAWING

Comprehension of the invention is facilitated by reading the following detailed description, in conjunction with the annexed drawing, in which:

FIGS. 1a and 1b are simplified schematic side and end representations, respectively, of a 10″ diameter dual stainless steel atomizer sprayer fan arrangement constructed in accordance with the invention;

FIG. 2 is an enlargement of the simplified schematic end representation of FIG. 1b;

FIG. 3 is a simplified schematic end representation of 12″ diameter, 72″ long dual stainless steel atomizer sprayer fan arrangement constructed in accordance with the invention;

FIG. 4 is a gray scale representation of a specific illustrative practicable embodiment of the invention;

FIG. 5 is a gray scale representation of a prior art orchard sprayer arrangement installed on a trailer;

FIG. 6 is an enlarged gray scale representation of a portion of the prior art orchard sprayer arrangement installed on a trailer shown in FIG. 5; and

FIG. 7 is a gray scale representation of a fan portion of the prior art orchard sprayer arrangement of FIGS. 5, and 6.

### DETAILED DESCRIPTION

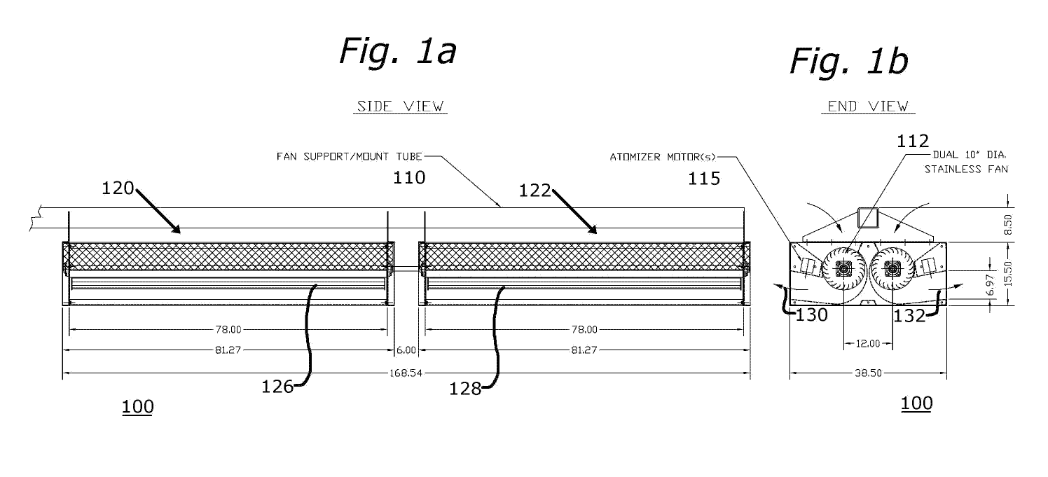

FIGS. 1a and 1b are simplified schematic side and end representations, respectively, of a 10″ diameter dual stainless steel atomizer sprayer fan arrangement 100 constructed in accordance with the principles of the invention. As shown in FIG. 1a, a fan support tube 110 contains therewithin a pair of stainless steel fans 112, the stainless steel fans being shown in an end view in FIG. 1b.

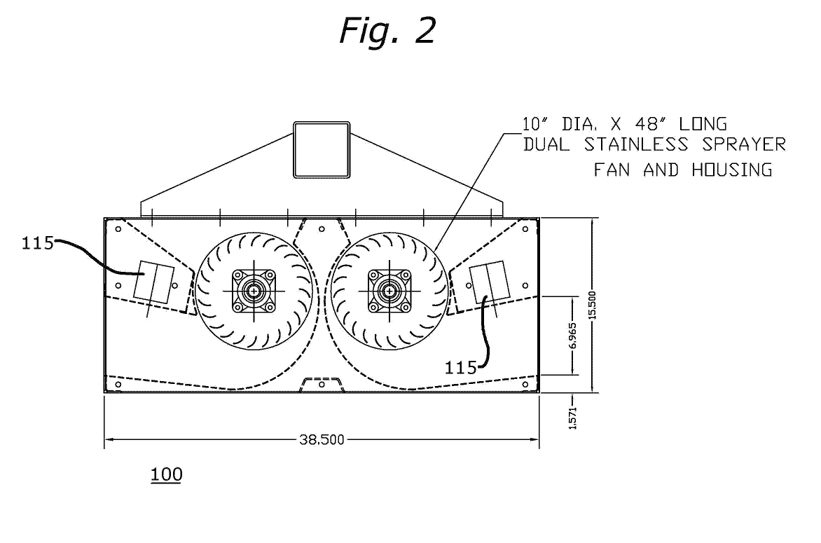

FIG. 2 is an enlargement of the simplified schematic end representation of FIG. 1b, and shows the components thereof with greater clarity. The specific illustrative embodiment of the invention shown in FIGS. 1a, 1b, and 2 is dimensioned to have an overall length of approximately 168.54″, and is comprised of a first and second sections 120 and 122, each having an overall length of approximately 81.27″. Fans 126 and 128 are themselves 78″ in length, and the first and second sections have, in this specific illustrative embodiment of the invention, a 6″ spacing is provided between their axes.

In operation, the fans are rotated in counter rotational relation whereby air flow is urged in the direction of curved arrows 130 and 132.

It is seen from FIGS. 1b and 2 that dual stainless steel atomizer sprayer fan arrangement 100 has an overall width of approximately 38.5″, and the fans are spaced approximately 12″ apart. It additionally seen that in this specific illustrative embodiment of the invention, the fans are rotated by a motor 210 that is coupled to the fans by a serpentine drive belt 212.

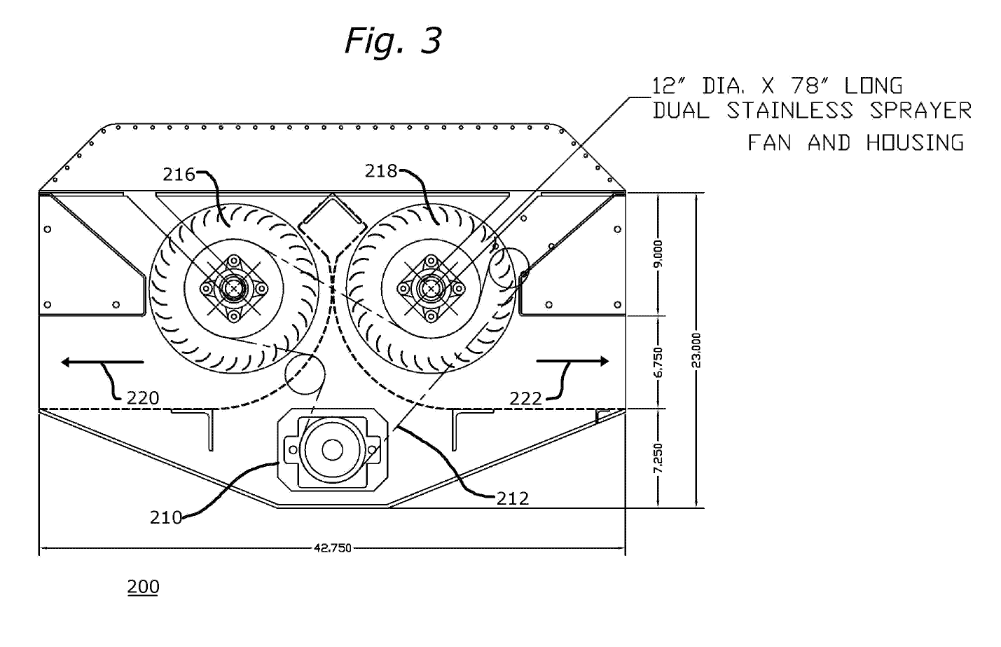

FIG. 3 is a simplified schematic end representation of 12″ diameter, 72″ long dual stainless steel atomizer sprayer fan arrangement 200 constructed in accordance with the invention. As shown in this figure, the sprayer fan arrangement has an overall width of approximately 42.75″ and the fans. As is the case with the embodiment of FIG. 1b, fans 216 and 218 are counter-rotated so that the air is urged in the direction of arrows 220 and 222, respectively.

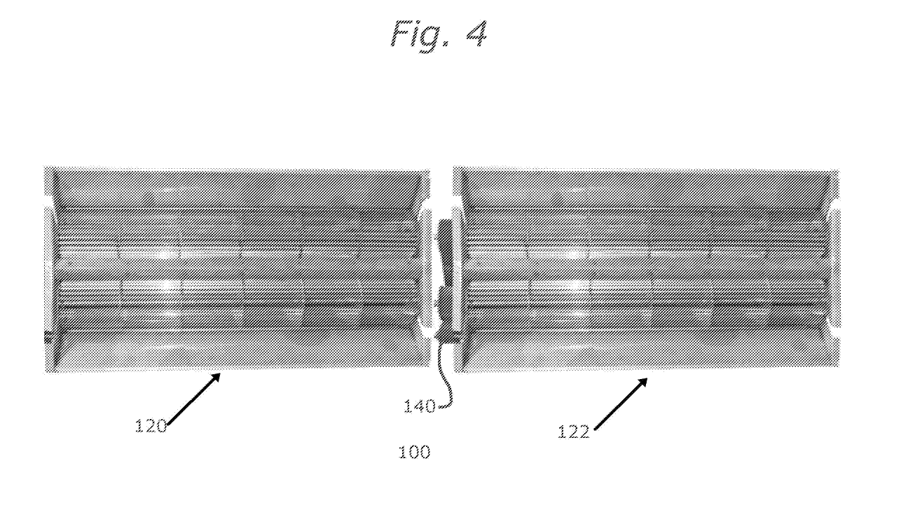

FIG. 4 is a gray scale representation of the specific illustrative practicable embodiment of the invention shown in FIGS. 1a, 1b, and 2. In this figure, it is seen that the fans are rotated by a serpentine drive belt 140.

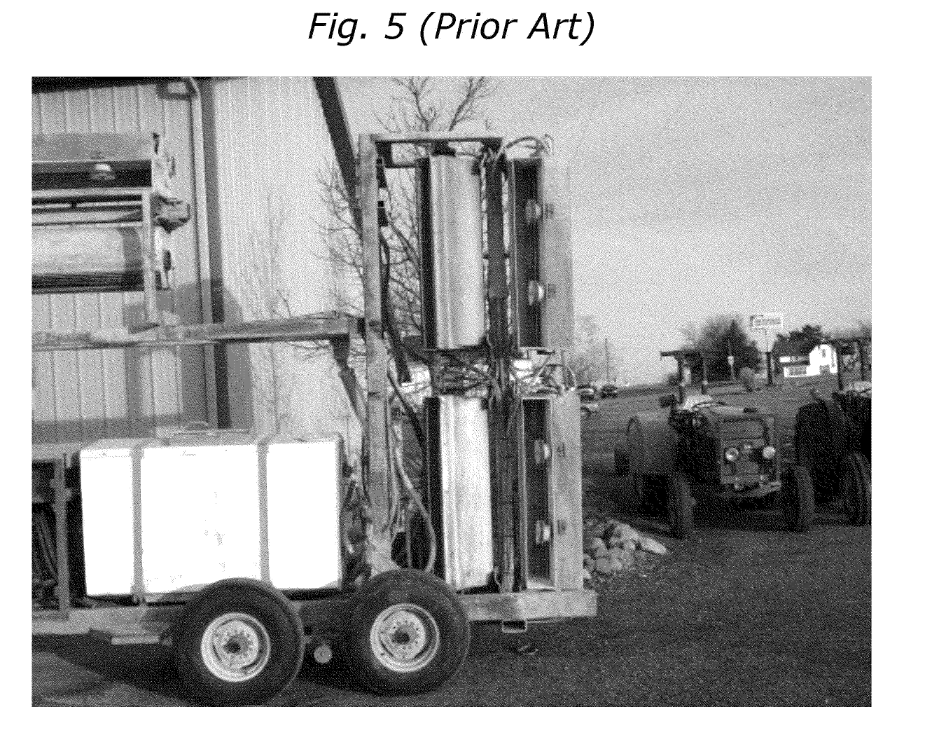

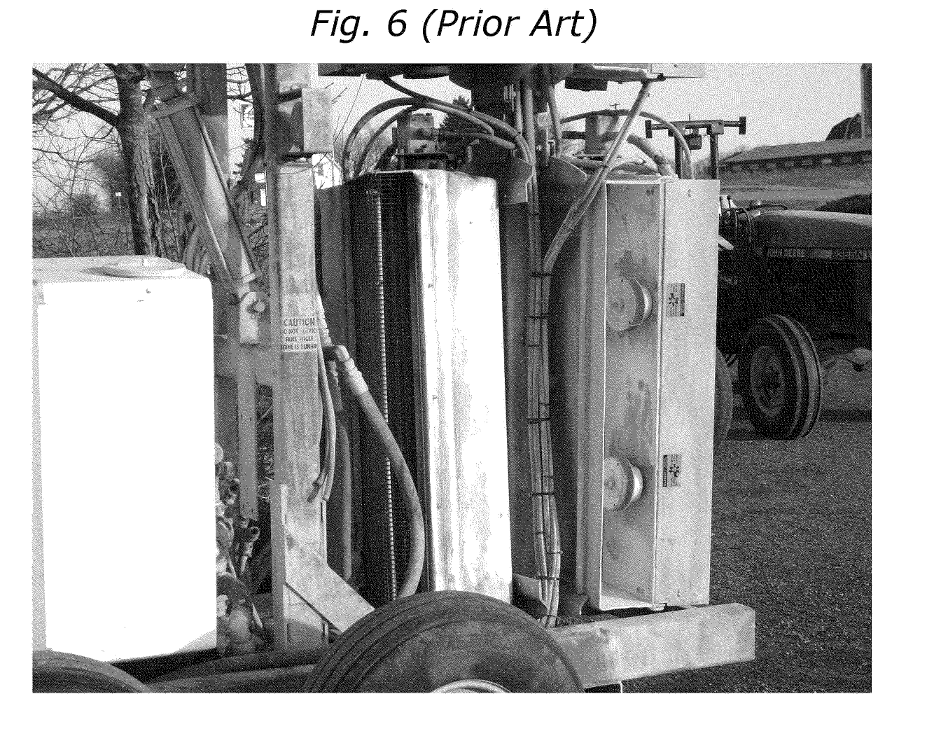

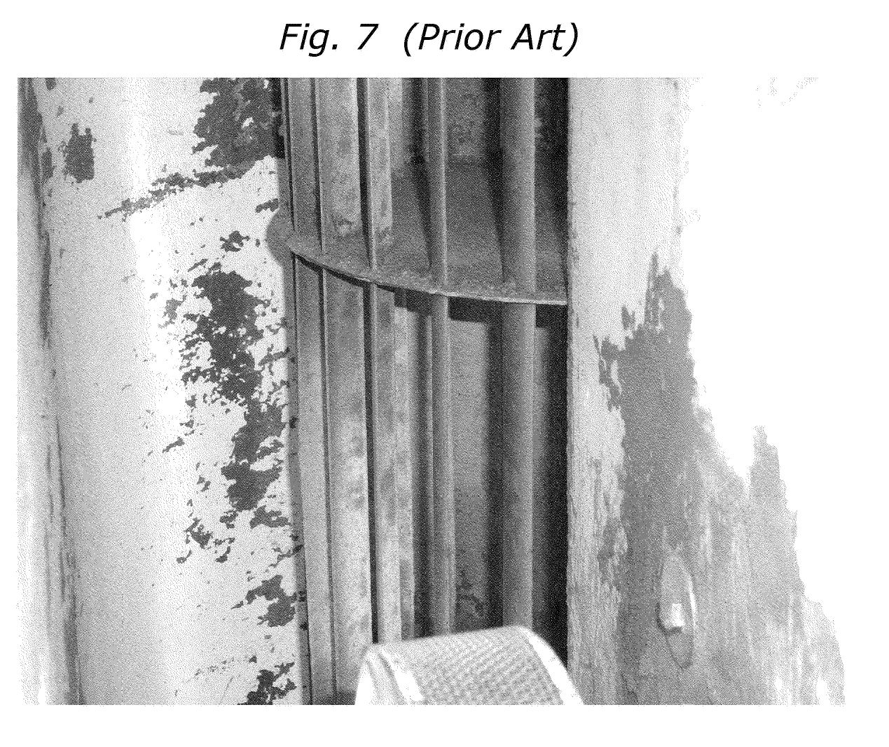

FIGS. 5, 6, and 7 are gray scale representations of a prior art orchard sprayer arrangement installed on a trailer. It is seen particularly in FIG. 7 that the prior art arrangement therein represented is a single fan system. The foregoing notwithstanding, the present invention can advantageously be installed on a trailer or cart, as can the prior art arrangement herein show, without significant modification.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

What is claimed is:

1. A sprayer arrangement having:
a pair of elongated fans arranged in axially parallel relation; and
a drive arrangement for rotating the elongated fans simultaneously in counter-rotation with respect to each other.

2. The sprayer arrangement of claim 1, wherein said drive arrangement comprises:
a motor; and
a coupler arrangement for coupling said motor to said pair of drive fans;

3. The sprayer arrangement of claim 2, wherein said coupler arrangement comprises a serpentine drive belt.

4. The sprayer arrangement of claim 1, wherein there is further provided an atomizer arrangement for delivering a material to be atomized to the vicinity of said pair of elongated fans.

5. The sprayer arrangement of claim 1, wherein said pair of elongated fans are configured to urge air in respective transaxial directions.

6. The sprayer arrangement of claim 5, wherein there is further provided a housing arranged to surround said pair of elongated fans, said housing having a pair of lateral ports for exhausting the air that is transaxially urged by said pair of elongated fans with the material to be atomized.
